(19) United States
(12) Patent Application Publication
(10) Pub. No.: US 2024/0128828 A1
(43) Pub. Date: Apr. 18, 2024

(54) Vehicle Drive Motor

(71) Applicant: Hitachi Astemo, Ltd., Hitachinaka-shi, Ibaraki (JP)

(72) Inventors: Kenta SUZUKI, Tokyo (JP); Shogo MIYAMOTO, Hitachinaka-shi, Ibaraki (JP); Takaki ITAYA, Hitachinaka-shi, Ibaraki (JP); Kosaku ONO, Tokyo (JP)

(21) Appl. No.: 18/273,124

(22) PCT Filed: Sep. 13, 2021
(86) PCT No.: PCT/JP2021/033454

§ 371 Date: Jul. 19, 2023

(30) Foreign Application Priority Data
Mar. 22, 2021 (JP) 2021-047126

(51) Int. Cl. H02K 5/20; F16H 57/04; H02K 9/197

(52) U.S. Cl. CPC H02K 5/203; F16H 57/0423; F16H 57/0476; H02K 9/197; H02K 5/1732

(57) ABSTRACT

Provided is a vehicle drive motor capable of maintaining lubrication of a bearing even in a case where an electric vehicle is not operated for a long period of time. The vehicle drive motor includes a casing in which a cylindrical stator coil is fixed to an inner peripheral surface and an oil passage is provided in an upper portion, an output shaft arranged in the casing and having a rotor fixed to a position facing the stator coil, a bearing that supports the output shaft, and an oil retaining portion that is arranged to face the bearing and stores oil supplied from the oil passage. The oil retaining portion is a pocket-shaped receptacle in which an upper side is lower than a lower end of the output shaft and a lower side is along a lower outer periphery of the bearing as viewed from an axial direction of the output shaft in front view.

### TECHNICAL FIELD

The present invention relates to a vehicle drive motor that generates a driving force of an electric vehicle, and more particularly to a vehicle drive motor that lubricates a bearing while a stator coil, a bearing, and the like is cooled with low-temperature oil.

### BACKGROUND ART

In a vehicle drive motor that achieves both high output and miniaturization, since a stator coil, a bearing, and the like have a high temperature when the motor is rotated at a high speed, it is necessary to cool the stator coil, the bearing, and the like. In addition, in the vehicle drive motor, since a lifetime rotation speed of the bearing increases, there is also a demand for eliminating a failure caused by oil shortage of the bearing.

Thus, for example, in PTL 1, a three-phase coil (stator coil) of a rotating electrical machine (motor), the bearing, and the like are cooled by oil discharged from above, and further the bearing is lubricated by the configuration illustrated in FIGS. 3 to 5 of PTL 1. Regarding this detail, in paragraph 0060 of PTL 1, it is described that “Oil discharged to substantially center portions of coil ends 20a and 20b and a three-phase coil 20 in an axial direction flows down to a lower portion of the three-phase coil 20 along a circumferential direction of the three-phase coil 20, and heat is transferred from the three-phase coil 20 to the oil while this oil flows down the three-phase coil 20, and a stator 18 is cooled. In particular, since the oil is supplied to the coil ends 20a and 20b having a highest temperature in the three-phase coil 20, the three-phase coil 20 is efficiently cooled”. Further, in paragraph 0068, it is described that “Thus, a bearing 43 provided outward of the motor M in the axial direction can be lubricated by using an oil pipe 44 that supplies oil for cooling the coil ends 20a and 20b of the motor M, and a new lubricating structure for lubricating the bearing 43 can be made unnecessary”.

### CITATION LIST

### Patent Literature

PTL 1: JP 5136688 B

### SUMMARY OF INVENTION

### Technical Problem

However, in PTL 1, when the rotating electrical machine (motor) is being driven, the bearing can be lubricated while the three-phase coil (stator coil) is cooled. However, in a case where the rotating electrical machine is not driven for a long period of time, oil in the vicinity of the bearing flows down, and the lubrication of the bearing is insufficient. Accordingly, there is a possibility that a failure factor is caused.

Therefore, an object of the present invention is to provide a vehicle drive motor capable of maintaining lubrication of a bearing even in a case where an electric vehicle is not operated for a long period of time.

### Solution to Problem

In order to solve the above problems, a vehicle drive motor includes a casing in which a cylindrical stator coil is fixed to an inner peripheral surface and an oil passage is provided in an upper portion, an output shaft arranged in the casing and having a rotor fixed to a position facing the stator coil, a bearing that supports the output shaft, and an oil retaining portion that is arranged to face the bearing and stores oil supplied from the oil passage. The oil retaining portion is a pocket-shaped receptacle in which an upper side is lower than a lower end of the output shaft and a lower side is along a lower outer periphery of the bearing as viewed from an axial direction of the output shaft in front view.

### Advantageous Effects of Invention

In accordance with the vehicle drive motor according to the present invention, the lubrication of the bearing can be maintained even in a case where the electric vehicle is not operated for a long period of time.

### BRIEF DESCRIPTION OF DRAWINGS

FIG. 1 is a sectional view of a vehicle drive motor according to a comparative example in an axial direction.

FIG. 2 is a sectional view of the vehicle drive motor according to the comparative example in a radial direction.

FIG. 3 is a sectional view of a vehicle drive motor according to a first embodiment in an axial direction.

FIG. 4 is a front view of a periphery of an oil retaining portion according to the first embodiment.

FIGS. 5A and 5B are first modifications of the oil retaining portion according to the first embodiment.

FIG. 6 is a second modification of the oil retaining portion according to the first embodiment.

FIG. 7 is a sectional view of a vehicle drive motor according to a second embodiment in an axial direction.

FIG. 8 is a sectional view for describing an assembly procedure of the vehicle drive motor in FIG. 7.

FIG. 9 is a first example in which the oil retaining portion according to the present invention is applied to a speed reducer.

FIG. 10 is a second example in which the oil retaining portion according to the present invention is applied to the speed reducer.

### DESCRIPTION OF EMBODIMENTS

### Comparative Example

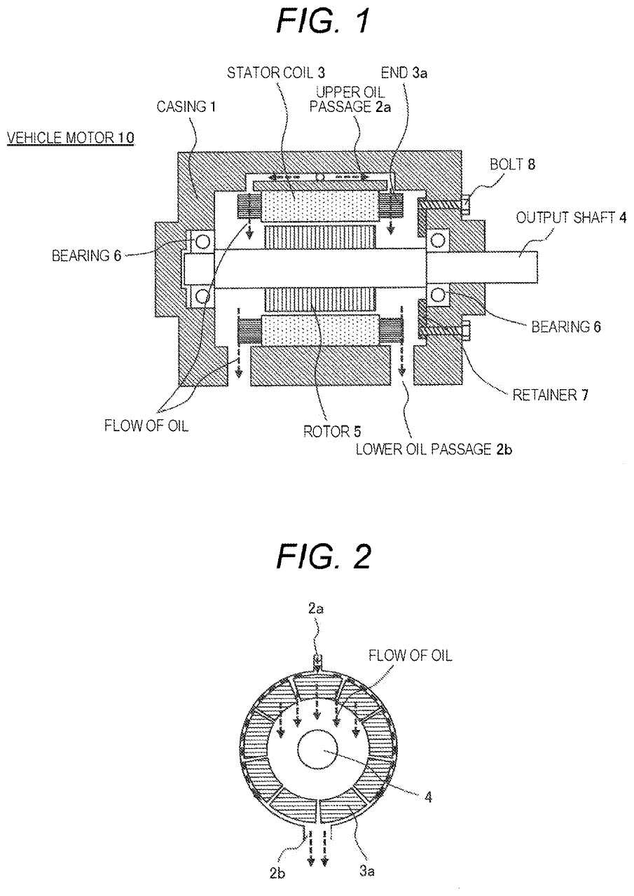

Before a vehicle drive motor according to the present invention is described, first, a vehicle drive motor 10 according to a comparative example will be described with reference to FIGS. 1 and 2. Note that, the vehicle drive motor 10 according to the comparative example is obtained by extracting and briefly displaying a configuration related to the present invention among configurations of an electric motor of PTL 1.

FIG. 1 is a sectional view of the vehicle drive motor 10 according to the comparative example in an axial direction. The vehicle drive motor 10 is incorporated in an electric vehicle such that a rotation axis is horizontal, and a downward direction in the drawing corresponds to a gravity direction after installation.

As illustrated here, the vehicle drive motor 10 according to the comparative example includes a casing 1 forming an outer shell, oil passages 2 (upper oil passage 2a and lower oil passage 2b) provided at upper and lower portions of the casing 1, a cylindrical stator coil 3 fixed to an inner peripheral surface of a cylindrical portion of the casing 1, an output shaft 4 arranged horizontally, a rotor 5 fixed to an outer periphery of the output shaft 4 at a position facing the stator coil 3, a pair of bearings 6 (for example, a roller bearing or a ball bearing) supporting the output shaft 4 at two portions, a retainer 7 restricting movement of one bearing 6 in the axial direction, and a bolt 8 fixing the retainer 7 to an end of an inner surface of the casing 1.

When a current is supplied from an inverter circuit (not illustrated) to the vehicle drive motor 10, the output shaft 4 on a rotor side rotates by a magnetic flux generated by a current flowing through the stator coil 3 on a stator side, and a driving force for driving the electric vehicle is output. At this time, it is necessary to cool the stator coil 3 having a high temperature due to the flow of the current, the bearing 6 having a high temperature due to a drag loss during high-speed rotation, and the like, and it is necessary to lubricate the bearing 6 in order to suppress the drag loss. Therefore, in the vehicle drive motor 10 according to the comparative example, the stator coil 3, the bearing 6, and the like are cooled by low-temperature oil supplied from an outside, and the bearing 6 is lubricated.

A broken-line arrow in the drawing indicates a direction in which the low-temperature oil supplied from the outside flows. The broken-line arrow indicates a scene in which oil discharged from a discharge hole of the upper oil passage 2a cools an end 3a as a highest-temperature portion and the stator coil 3 thermally connected to the end, flows down, is stirred and splashed by the output shaft 4 rotating at a high speed, lubricates the bearing 6, and then is discharged to an outside of the vehicle drive motor 10 from the lower oil passage 2b penetrating a lower portion of the casing 1. Note that, oil supplied to the upper oil passage 2a may be wound up by a speed reducer 20 to be described in a third embodiment or may be sucked up by a pump.

FIG. 2 is a diagram of a flow of oil in FIG. 1 as viewed from another direction, and is a sectional view of the vehicle drive motor 10 in a radial direction at a position including the right end 3a in FIG. 1. Note that, illustration of an outer peripheral surface of the casing 1 is omitted here. As illustrated here, the oil discharged from the discharge hole of the upper oil passage 2a is divided into oil flowing along the inner peripheral surface of the casing 1 and oil falling from the upper end 3a. The former oil sequentially cools the end 3a of the stator coil 3 arranged along the inner peripheral surface of the casing 1. On the other hand, the latter oil is stirred and splashed by the output shaft 4 rotating at a high speed, and a part thereof reaches the bearing 6 to cool and lubricate the bearing 6. By doing this, in the vehicle drive motor 10 according to the comparative example, the cooling of the stator coil 3 and the bearing 6 and the lubrication of the bearing 6 can be realized.

### First Embodiment

However, in the vehicle drive motor 10 according to the comparative example, since the rotation of the output shaft 4 is used to supply the oil to the bearing 6, in a case where the electric vehicle is not operated for a long period of time, the oil in the vicinity of the bearing 6 flows down. Thus, there is a possibility that the drag loss of the bearing 6 increases due to insufficient lubrication of the bearing 6 and a failure of the vehicle drive motor 10 occurs during a next operation. In particular, in a case where the winding up of the speed reducer is used to supply the oil, immediately after the start of the vehicle drive motor 10, since a rotational speed of a gear of the speed reducer is slow and the amount of oil wound up is small, this problem becomes more important.

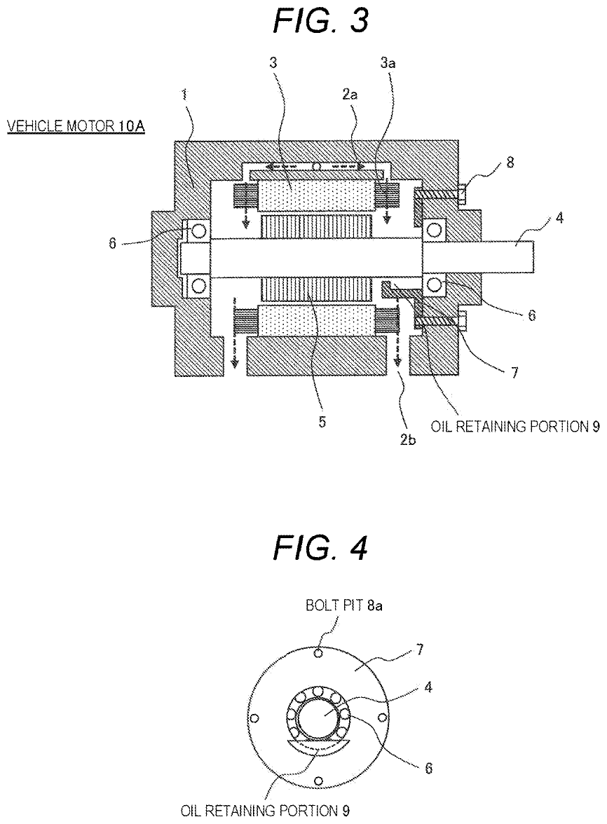

Therefore, in a vehicle drive motor 10A according to a first embodiment of the present invention illustrated in FIGS. 3 to 6, even in a case where the electric vehicle is not operated for a long period of time, at least the bearing 6 on an output end side can maintain lubrication. Note that, in the following description, redundant description of configurations equivalent to the configurations of the comparative example will be omitted.

FIG. 3 is a sectional view of the vehicle drive motor 10A according to the first embodiment in an axial direction. The vehicle drive motor 10A is obtained by further adding an oil retaining portion 9 facing the bearing 6 on the output end side to the configuration of the vehicle drive motor 10 according to the comparative example. The oil retaining portion 9 is a receptacle member in which a part of a lower half of the retainer 7 is extended to a lower side of the end 3a of the stator coil 3, and stores relatively low-temperature oil which drips from the upper end 3a and is stirred and splashed by the output shaft 4 rotating at a high speed, and supplies the oil to the bearing 6. Note that, in FIG. 3, in order to reduce the number of components, the prevention retainer 7 and the oil retaining portion 9 are integrally formed, but the retainer and the oil retaining portion may be separately formed.

FIG. 4 is a front view of a periphery of the oil retaining portion 9 of the present embodiment. As illustrated here, the oil retaining portion 9 is a pocket-shaped receptacle member in which an upper side is lower than a lower end of the output shaft 4 and a lower side is along a lower outer periphery of the bearing 6 as viewed from an axial direction in front view. Even in a case where the electric vehicle is not operated for a long period of time, since the lubrication of the bearing 6 can be maintained by the oil stored in the oil retaining portion 9 during a previous operation by providing such an oil retaining portion 9, the electric vehicle can be driven in a state where the bearing 6 is appropriately lubricated at the start of the next operation.

As described above, according to the vehicle drive motor 10A of the present embodiment, the lubrication of the bearing of the motor can be maintained even in a case where the electric vehicle is not operated for a long period of time.

<First Modification of Oil Retaining Portion>

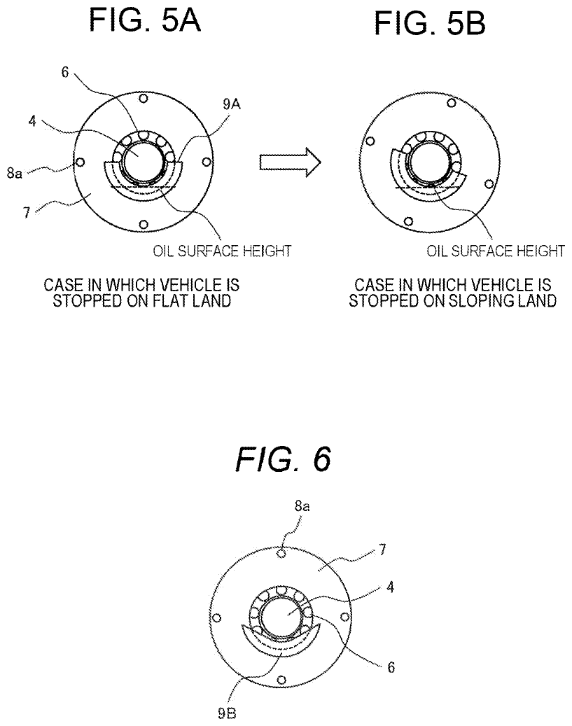

Next, a modification of the oil retaining portion 9 in FIG. 4 will be described with reference to FIGS. 5A and 5B. In the oil retaining portion 9 in FIG. 4, in order to suppress an increase in a stirring loss of the bearing 6, the amount of oil in the oil retaining portion 9 is suppressed to be equal to or less than a desired amount by adopting a relatively shallow receptacle shape. However, after the driving of the vehicle drive motor LA is ended, since the oil is scraped out from the oil retaining portion 9 by a centrifugal force during inertial rotation of the bearing 6, when the vehicle drive motor LA having a characteristic that a duration of the inertial rotation is long adopts the oil retaining portion 9 having the shallow receptacle shape, there is a possibility that the remaining amount of oil in the oil retaining portion 9 is insufficient. In addition, in a case where the electric vehicle is parked on a slope, one end side of the oil retaining portion 9 may be lowered, and a possibility that the oil flows out from the oil retaining portion and the remaining amount of oil is insufficient is also considered.

Therefore, in an oil retaining portion 9A in FIGS. 5A and 5B, as illustrated in a left diagram in FIGS. 5A and 5B, a substantially U-shaped shape surrounding the outer periphery of the output shaft 4 and having an upper end height substantially equal to a center height of the output shaft 4 as viewed from an axial direction in front view is adopted. Consequently, since it is possible to store more oil than the oil retaining portion 9 in FIG. 4 during the driving of the vehicle drive motor LA, it is possible to secure the sufficient remaining amount of oil even though a part of the oil is scraped out by a centrifugal force during inertial rotation of the bearing 6. In addition, even in a case where the electric vehicle is parked on a slope, the oil retaining portion 9A takes a posture illustrated in a right diagram in FIGS. 5A and 5B, and a part of the oil flows out from a right side of the oil retaining portion 9A, it is possible to maintain the sufficient remaining amount of oil required in the bearing 6 during a next operation.

<Second Modification of Oil Retaining Portion>

Next, a modification of the oil retaining portion 9A in FIGS. 5A and 5B will be described with reference to FIG. 6. Although the oil retaining portion 9A in FIGS. 5A and 5B can store the sufficient amount of oil, the remaining amount of oil in the oil retaining portion 9A may be excessive, and there is a possibility that a stirring resistance of the bearing 6 is excessive during the driving of the vehicle drive motor 10A.

Therefore, in an oil retaining portion 9B in FIG. 6, as viewed from an axial direction in front view, a substantially crescent-shaped receptacle surrounding the outer periphery of the output shaft 4 and having an upper end height substantially equal to the center height of the output shaft 4 is adopted. Consequently, during the driving of the vehicle drive motor 10A, since excessive oil is discharged from a low portion of an upper side of the oil retaining portion 9B, the amount of oil in the oil retaining portion 9B can be suppressed to some extent, and a stirring resistance in the bearing 6 can be suppressed. In addition, since an upper end of the oil retaining portion 9B has the same height as the upper end of the oil retaining portion 9A in FIGS. 5A and 5B, when the electric vehicle is parked on a slope, it is possible to maintain the sufficient remaining amount of oil in the oil retaining portion 9B by an action equivalent to the action illustrated in the right diagram in FIGS. 5A and 5B.

### Second Embodiment

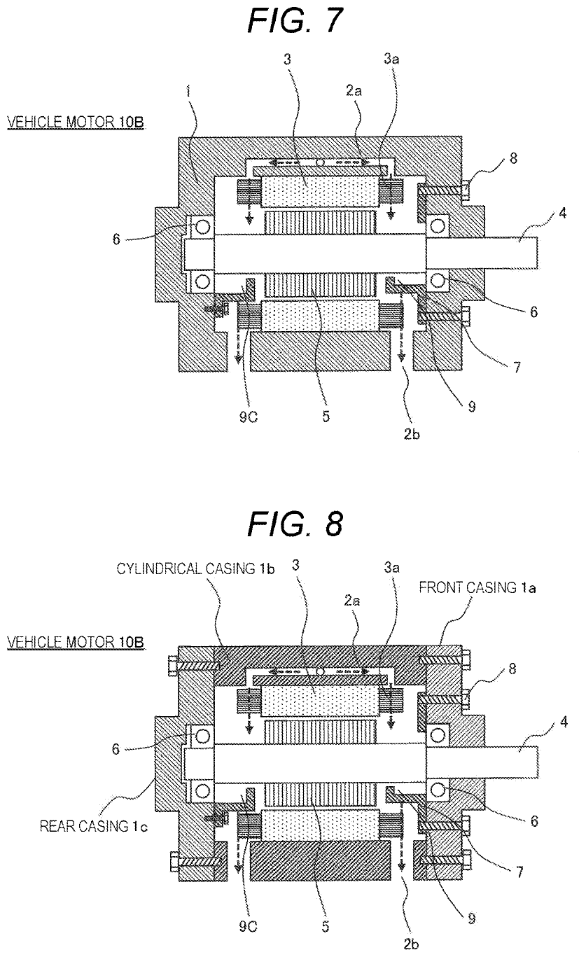

Next, a vehicle drive motor 10B according to a second embodiment will be described with reference to FIGS. 7 and 8. Note that, in the following description, redundant description of configurations equivalent to the configurations of the first embodiment will be omitted.

In the vehicle drive motor LA according to the first embodiment, as illustrated in FIG. 3, the oil retaining portion 9 is provided for the right bearing 6 on an output end side, but the oil retaining portion is not provided for the left bearing 6. On the other hand, in the vehicle drive motor 10B of the present embodiment, as illustrated in the sectional view in FIG. 7, an oil retaining portion 9C is also provided for the left bearing 6, and lubrication can be maintained for the left bearing 6. Note that, as a shape of the oil retaining portion 9C in front view in FIG. 7, any of the oil retaining portion 9 in FIG. 4, the oil retaining portion 9A in FIGS. 5A and 5B, and the oil retaining portion 9B in FIG. 6 may be adopted.

In FIG. 7, the retainer 7 that suppresses the movement in the axial direction is provided for the right bearing 6 as in the first embodiment, but the left bearing 6 press-fitted to a left end of the output shaft 4 does not need to overlapped and fixed with another retainer as long as the movement of the output shaft 4 in the axial direction is suppressed by the retainer 7. Thus, for the left oil retaining portion 9C, a portion corresponding to the retainer is omitted in consideration of an assembly procedure to be described later.

FIG. 8 more specifically illustrates a structure of the vehicle drive motor 10B in FIG. 7. In FIG. 8, the casing 1 includes a front casing 1a, a cylindrical casing 1b, and a rear casing 1c. In a case where such a casing 1 is used, the vehicle drive motor 10B is assembled by the following procedure.

First, the stator coil 3 is fixed to the inner peripheral surface of the cylindrical casing 1b.

Subsequently, after the bearing 6 is press-fitted to a right side of the output shaft 4, the bearing 6 is inserted into an inner surface of the front casing 1a. The retainer 7 is fixed to the inner surface of the front casing 1a with a bolt to fix positions of the right bearing 6 and the output shaft 4 in the axial direction. Thereafter, the rotor 5 is fixed to a center of the output shaft 4, the left bearing 6 is press-fitted into a distal end of the output shaft 4, and then the front casing 1a is fastened to the cylindrical casing 1b with a bolt. Further, after the oil retaining portion 9C is fastened to the rear casing 1c with a bolt, the rear casing 1c is fastened to the cylindrical casing 1b with a bolt. According to such an assembly procedure, the vehicle drive motor 10B provided with the oil retaining portions 9 and 9C in the vicinity of the left and right bearings can be manufactured.

### Third Embodiment

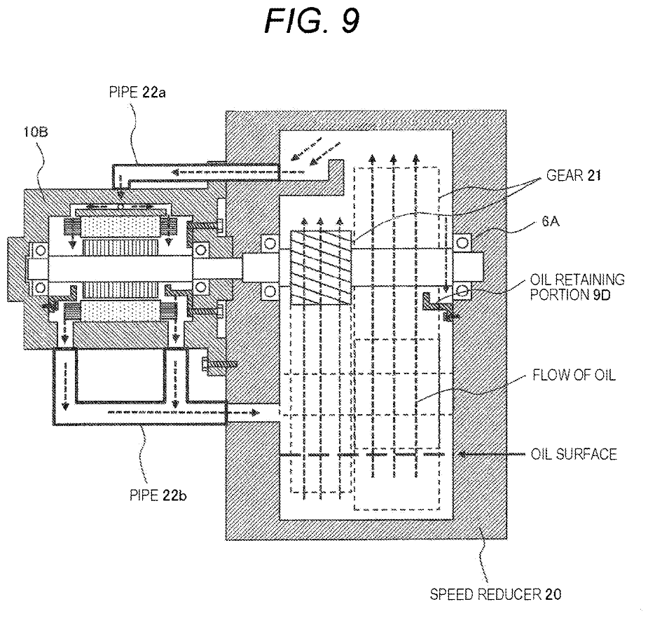

Next, a configuration example in which the present invention is applied to the speed reducer 20 connected to an output side of the vehicle drive motor will be described with reference to FIG. 9. Note that, any of the vehicle drive motor 10 according to the comparative example and the vehicle drive motors 10A and 10B of the above-described embodiments may be used as the vehicle drive motor of the present embodiment, but a configuration using the vehicle drive motor 10B will be described below.

As illustrated in FIG. 9, the speed reducer 20 of the present embodiment is a device connected to the output side of the vehicle drive motor 10B, and converts an output of low-torque high-speed rotation of the output shaft 4 of the vehicle drive motor 10B into a driving force of high-torque low-speed rotation by combining a plurality of gears 21.

In the speed reducer 20, the low-temperature oil wound up from a lower oil reservoir by the group of gears 21 is supplied to the upper oil passage 2a of the vehicle drive motor 10B through a pipe 22a, and a high-temperature oil discharged from the lower oil passage 2b of the vehicle drive motor 10B circulates to the speed reducer 20 through a pipe 22b. The high-temperature oil that has returned from the vehicle drive motor 10B to the speed reducer 20 is dissipated in the lower oil reservoir of the speed reducer 20 and becomes a low temperature.

Here, among the gears 21 of the speed reducer 20, the gear coaxial with the output shaft 4 of the vehicle drive motor 10B rotates at a high speed at a constant speed with respect to the output shaft 4. When the gear 21 is, for example, a helical gear, since a bearing 6A supporting a shaft of the gear 21 receives loads in a radial direction and an axial direction, there is a possibility that the bearing is used under more severe conditions than the bearing 6 of the vehicle drive motor 10B. Thus, in the present embodiment, a similar oil retaining portion 9D as in the first embodiment and the second embodiment is also installed in the bearing 6A of the speed reducer 20.

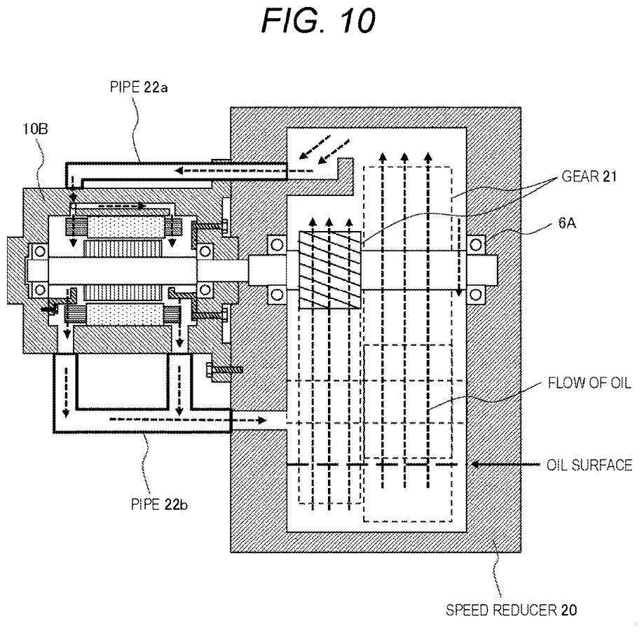

FIG. 10 illustrates an example in a case where the amount of heat generation is different between left and right ends of the stator coil 3. This example illustrates a case where the amount of heat generation at the left end is large, and the pipe 22a is connected to the vicinity of the left end of the stator coil 3. With this structure, it is possible to further cool the coil on a side where the amount of heat generation is large.

Consequently, similarly to the vehicle drive motors 10A and 10B of the above-described embodiments, even in the speed reducer 20 of the present embodiment, the lubrication of the bearing of the speed reducer can be maintained even in a case where the electric vehicle is not operated for a long period of time.

### REFERENCE SIGNS LIST

10, 10A, 10B vehicle drive motor
1 casing
1a front casing
1b cylindrical casing
1c rear casing
2 oil passage
2a upper oil passage
2b lower oil passage
3 stator coil
3a end
4 output shaft
5 rotor
6 bearing
7 retainer
8 bolt
8a bolt pit
9 oil retaining portion
20 speed reducer
21 gear
22 pipe

1. A vehicle drive motor, comprising:
a casing in which a cylindrical stator coil is fixed to an inner peripheral surface and an oil passage is provided in an upper portion;
an output shaft arranged in the casing and having a rotor fixed to a position facing the stator coil;
a bearing that supports the output shaft; and
an oil retaining portion that is arranged to face the bearing and stores oil supplied from the oil passage,
wherein the oil retaining portion is a pocket-shaped receptacle in which an upper side is lower than a lower end of the output shaft and a lower side is along a lower outer periphery of the bearing as viewed from an axial direction of the output shaft in front view.

2. The vehicle drive motor according to claim 1, wherein
the oil retaining portion is a substantially U-shaped receptacle which surrounds an outer periphery of the output shaft and in which an upper end height is substantially equal to a center height of the output shaft as viewed from the axial direction of the output shaft in front view.

3. The vehicle drive motor according to claim 1, wherein
the oil retaining portion is a substantially crescent-shaped receptacle which surrounds an outer periphery of the output shaft and in which an upper end height is substantially equal to a center height of the output shaft as viewed from the axial direction of the output shaft in front view.

4. The vehicle drive motor according to claim 1, wherein
the oil retaining portion is formed integrally with a retainer restricting movement of the bearing in an axial direction.

5. The vehicle drive motor according to claim 1, wherein
the output shaft is supported by a pair of bearings, and the oil retaining portion is provided for each of the bearings.
